(19) United States
(12) Patent Application Publication
(10) Pub. No.: US 2018/0048360 A1
(43) Pub. Date: Feb. 15, 2018

(54) DEVICE AND A METHOD FOR CONTROLLING A GRID OF BEAMS

(71) Applicant: Telefonaktiebolaget LM Ericsson (publ), Stockholm (SE)

(72) Inventors: Fredrik ATHLEY, Kullavik (SE); Andreas NILSSON, Göteborg (SE); Sven PETERSSON, Sävedalen (SE)

(73) Assignee: Telefonaktiebolaget LM Ericsson (publ), Stockholm (SE)

(21) Appl. No.: 15/794,451

(22) Filed: Oct. 26, 2017

Related U.S. Application Data
(63) Continuation of application No. PCT/EP2015/059205, filed on Apr. 28, 2015.

(51) Int. Cl. H04B 7/0408; H04B 7/06; H04W 48/18; H04W 12/06; H04W 12/08; H04B 7/0452; H04W 8/08

(52) U.S. Cl. CPC H04B 7/0408; H04B 7/0452; H04B 7/0617; H04W 8/082; H04W 12/06; H04W 12/08; H04W 48/18; H04W 16/28

(57) ABSTRACT

The present disclosure relates to a wireless communication network node comprising at least one antenna arrangement. Each antenna arrangement is arranged to communicate with user terminals by means of at least two antenna beams constituting a grid of beams. Each user terminal is arranged to communicate via at least one respective antenna beam that is selected in dependence of received power from said antenna beams. The node comprises a control unit that is arranged to control a power pattern of at least two controlled antenna beams in dependence of estimated signal power and interference created by each of said controlled antenna beams, where each power pattern is defined as a product of the corresponding antenna beam's radiation pattern and transmitted power.

### CROSS-REFERENCE TO RELATED APPLICATIONS

This application is a continuation of International Patent Application no. PCT/EP2015/059205, filed on Apr. 28, 2015 (published as WO 2016/173627). The above identified application and publication are incorporated by reference.

### TECHNICAL FIELD

The present disclosure relates to a wireless communication network node comprising at least one antenna arrangement, each antenna arrangement being arranged to communicate with user terminals by means of at least two antenna beams constituting a grid of beams.

### BACKGROUND

It is desired to acquire a high degree of capacity in wireless communication networks. One technique to increase capacity in a wireless communication network is to deploy so-called massive beamforming, which is a central component in the next generation of mobile communications, 5G. One envisioned solution is that each wireless communication network node has a large number of narrow fixed beams that a user terminal can be connected to, so called grid-of-beams beamforming. One potential difference compared to current systems is that the traditional cell concept is relaxed so that user terminals connect to and perform handover between such beams instead of cells.

Traditional cell-based networks usually require cell-planning in order to minimize interference between cells. This is normally achieved by transmitting cell-defining reference signals, such as CRS (Cell-specific Reference Signals) in LTE (Long-Term Evolution), through beam patterns that are shaped to provide sufficient coverage while maintaining low inter-cell interference, e.g. a down-tilted conventional sector antenna.

For a beam-based system according to the above, using grid-of-beams beamforming, there is a risk that these interference control measures are lost if the beam selection is based only on received signal power.

### SUMMARY

It is an object of the present disclosure to provide a beam-based system according to the above with reduced interference.

Said object is obtained by means of a wireless communication network node comprising at least one antenna arrangement. Each antenna arrangement is arranged to communicate with user terminals by means of at least two antenna beams constituting a grid of beams. Each user terminal is arranged to communicate via at least one respective antenna beam that is selected in dependence of received power from said antenna beams. The wireless communication network node comprises a control unit that is arranged to control a power pattern of at least two controlled antenna beams in dependence of estimated signal power and interference created by each of said controlled antenna beams. Each power pattern is defined as a product of the corresponding antenna beam's radiation pattern and transmitted power.

Said object is also obtained by means of a method in a wireless communication network node, where the method comprises: Communicating with user terminals by means of at least two antenna beams constituting a grid of beams; Communicating with each user terminal via at least one respective antenna beam that is selected in dependence of received power from said antenna beams; and Controlling a power pattern of at least two controlled antenna beams in dependence of estimated signal power and interference created by each of said controlled antenna beams, where each power pattern is defined as a product of the corresponding antenna beam's radiation pattern and transmitted power.

According to an example, the control unit is arranged to control the power pattern of each antenna beam such that a desired envelope of the power patterns of all antenna beams is obtained.

According to another example, the control unit is arranged to first determine a desired shape of said envelope, and from that desired shape derive the corresponding output power of the respective antenna beam.

According to another example, the control unit is arranged to determine a desired shape of said envelope by defining a set of candidate envelope shapes for a given node, tune the output power of the respective antenna beam in accordance with the candidate envelope shapes, evaluate performance for each one of the candidate envelope shapes and then choose the candidate envelope shape that best fulfills certain predetermined criteria.

According to another example, the power patterns are controlled in dependence of results from interference and traffic load analysis, visual observations of the network deployment, and/or continuous non-disruptive network measurements.

According to another example, each user terminal is arranged to communicate via one antenna beam that is selected in dependence of received beam reference signal power of beam-specific reference signals (BRSs) transmitted via the antenna beams.

More examples are disclosed in the dependent claims.

A number of advantages are obtained by means of the present disclosure. Mainly, interference and traffic load imbalance of a grid-of-beams antenna arrangement is handled in more reliable and efficient manner.

### BRIEF DESCRIPTION OF THE DRAWINGS

The present disclosure will now be described more in detail with reference to the appended drawings, where:

FIG. 1 shows a schematic side view of a wireless communication network node for a first power pattern configuration;

FIG. 2 shows a schematic side view of a wireless communication network node for a second power pattern configuration;

FIG. 3 shows a schematic front view of an antenna arrangement and beamforming arrangement;

FIG. 4 shows a flow chart of a method according to the present disclosure;

FIG. 5 shows a flow chart for details in a method step;

FIG. 6 illustrates a wireless communication network node arrangement according to some aspects of the present disclosure; and

FIG. 7 illustrates optional components of an optional determining module.

### DETAILED DESCRIPTION

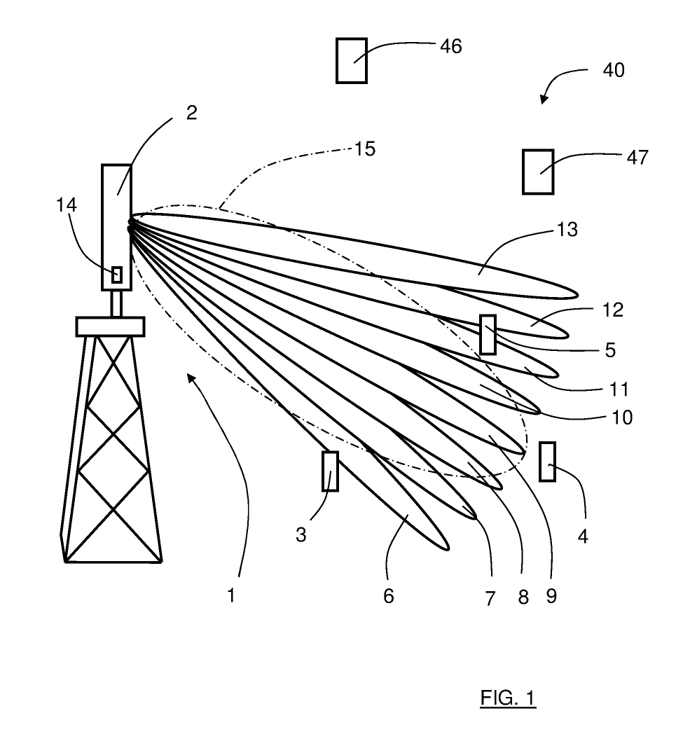

With reference to FIG. 1, a schematic side view of a wireless communication network node 1 in a wireless communication network 40 is shown. The node 1 comprises an antenna arrangement 2 that is arranged to communicate with a first user terminal 3, a second user terminal 4 and a third user terminal 5. This communication is achieved via a first antenna beam 6, a second antenna beam 7, a third antenna beam 8, a fourth antenna beam 9, a fifth antenna beam 10, a sixth antenna beam 11, a seventh antenna beam 12 and an eighth antenna beam 13, the antenna beams 6, 7, 8, 9, 10, 11, 12, 13 constituting a grid of beams.

In this example, the first user terminal 3 is arranged to communicate via the first antenna beam 6, the second user terminal 4 is arranged to communicate via the fourth antenna beam 9 and the third user terminal 5 is arranged to communicate via the seventh antenna beam 12, where the corresponding antenna beams 6, 9, 12 have been selected in dependence of detected received power at the user terminals 2, 3, 5 from all antenna beams 6, 7, 8, 9, 10, 11, 12, 13. As apparent, the third user terminal 5 will experience interference from the sixth antenna beam 11, which is undesired.

According to the present disclosure, the node 1 comprises a control unit 14 that is arranged to control a power pattern of all antenna beams 6, 7, 8, 9, 10, 11, 12, 13 in dependence of estimated signal power and interference created by each of the antenna beams 6, 7, 8, 9, 10, 11, 12, 13. Here, each power pattern is defined as a product of the corresponding antenna beam's radiation pattern and transmitted power, and the power pattern of each antenna beam 6, 7, 8, 9, 10, 11, 12, 13 is controlled such that a desired envelope of the power patterns of all antenna beams 6, 7, 8, 9, 10, 11, 12, 15 is obtained. The estimated signal power and interference created by each of the antenna beams 6, 7, 8, 9, 10, 11, 12, 13 may be estimated in a plurality of ways as will be described later.

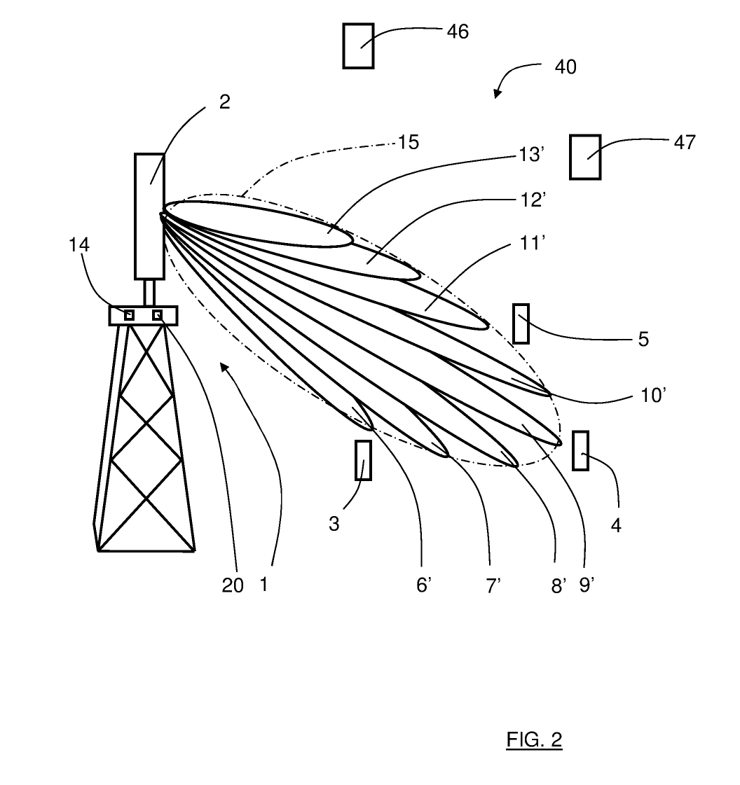

As shown in FIG. 2, the power patterns of all antenna beams 6′, 7′, 8′, 9′, 10′, 11′, 12′, 13′ have been controlled such that a desired envelope 15 is obtained, and in this way interference is reduced. The control is here in the form of reduction of transmitted power for the power patterns. Suitably, the control unit 14 is arranged to first determine a desired shape of the envelope 15, and from that desired shape derive the corresponding output power of the respective antenna beam 6, 7, 8, 9, 10, 11, 12, 13; 6′, 7′, 8′, 9′, 10′, 11′, 12′, 13′. By finding a desired shape of the envelope 15, the output power of respective beam 6, 7, 8, 9, 10, 11, 12, 13; 6′, 7′, 8′, 9′, 10′, 11′, 12′, 13′ could easily be derived. In this way, the number of degrees of freedom when tuning the output power for the beams 6, 7, 8, 9, 10, 11, 12, 13; 6′, 7′, 8′, 9′, 10′, 11′, 12′, 13′ is reduced, which might otherwise be too large if the output power of respective beam is tuned individually.

In order to determine a desired shape of said envelope 15, the control unit 14 may for example be arranged to define a set of candidate envelope shapes for the node 1, tune the output power of the respective antenna beam, evaluate performance for each one of the candidate envelope shapes and then choose the candidate envelope shape that best fulfills certain predetermined criteria such as traffic distribution, user throughput and interference environment. The evaluation may for example be made in dependence of results from interference and traffic load analysis, visual observations of the network deployment, and/or continuous non-disruptive network measurements. This evaluation constitutes an example of estimation of signal power and interference created by each of the antenna beams 6, 7, 8, 9, 10, 11, 12, 13.

One way to try out these candidate shapes is to transmit CSI-RS signals over beams shaped in the same way as the candidate envelope shapes. The user terminals 3, 4, 5 can then do RSRP (Reference Signal Received Power) measurements on the CSI-RS:s (Channel State Information Reference Signals) of respective envelope candidate shapes and report the measurements to the control unit 14. Based on these measurements, constituting an example of estimation of signal power and interference created by each of the antenna beams 6, 7, 8, 9, 10, 11, 12, 13, the control unit 14 can determine a preferred shape of the envelope 15.

Another way to estimate signal power and interference created by each of the antenna beams 6, 7, 8, 9, 10, 11, 12, 13 is to use cell-planning tools and determine desired beamwidths and pointing directions of the radiation pattern of the envelope 15. The next step is to set the output power of each beam so that the desired envelope shape is obtained.

The envelope 15 may be updated on a rather slow time-scale, for example when a new node has been deployed in the system, or when the traffic distribution changes between night-time traffic and day-time traffic. Alternatively, the envelope 15 may be updated based on continuous, non-disruptive measurements in the network for example RSRP measurements at the user terminals 3, 4, 5 on BRSs (beam-specific reference signals) or CSI-RS.

Each user terminal 3, 4, 5 may be arranged to communicate via one antenna beam 6, 7, 8, 9, 10, 11, 12, 13; 6′, 7′, 8′, 9′, 10′, 11′, 12′, 13′ that is selected in dependence of received beam reference signal power of (BRSs).

The control unit 14 may be arranged to apply different output power for BRSs and data signals at each antenna beam 6, 7, 8, 9, 10, 11, 12, 13; 6′, 7′, 8′, 9′, 10′, 11′, 12′, 13′. In this way it is possible to perform load balancing between different beams and different nodes where there are more nodes 46, 47 in the network 40, as well as indirectly controlling the interference situation in the network 40. By tuning the output power of the data signals, it is possible to directly impact the interference generation created by that beam. In some cases, it may be desired to have a small output power on a BRS to decrease the traffic load for that beam while at the same time have a large output power of the data signals in order to get good SNR (Signal to Noise Ratio) and high user throughput. In other situations, it may be desired to have a large output power on a BRS to offload traffic from other nodes 46, 47 while at the same time have a low output power on the data signals in order to reduce the generation of inter-beam interference.

For example, the relation between output power of the BRSs and data signals can depend on the traffic load in the system so that higher data output power can be used during low-traffic hours, e.g. during night-time, when interference is not a problem.

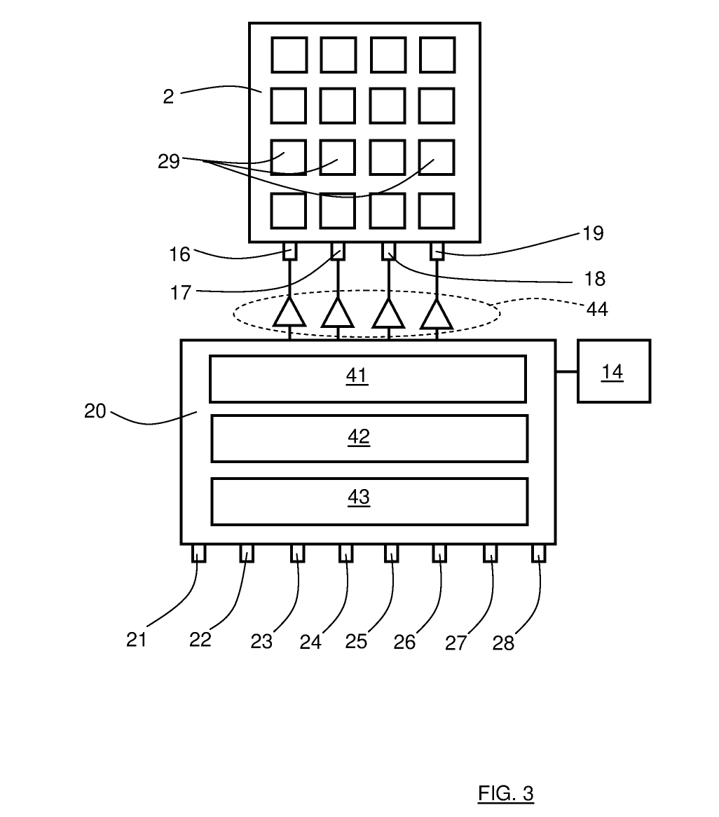

With reference to FIG. 3, the antenna arrangement comprises a plurality of antenna elements 29 and four antenna ports 16, 17, 18, 19 that in turn are connected to a beamforming arrangement 20. The beamforming arrangement 20 comprises eight beam ports 21, 22, 23, 24, 25, 26, 27, 28; one beam port for each antenna beam 6, 7, 8, 9, 10, 11, 12, 13. In this example, the beamforming arrangement 20 comprises a mixer device 41, an A/D (Analogue to Digital) converter device 42 and a digital beamformer device 43. The mixer device 41 shifts the frequency of RF (Radio Frequency) signals, the A/D device converts analogue base band signals to digital base band signals, and the digital beamformer device 43 applies beamforming to the digital base band signals.

Alternatively, the beamforming arrangement 20 may be based on analogue technology.

As shown in FIG. 3, power amplifiers 44 may be connected to each antenna port 16, 17, 18, 19 such that the power resources can be divided between the different beams. If one beam transmits with reduced output power, another beam can transmit with the remaining power resources. Alternately, for the same reason, a power amplifier may be connected to each antenna element or group of antenna elements (not shown).

Alternatively, the antenna beams 6, 7, 8, 9, 10, 11, 12, 13; 6′, 7′, 8′, 9′, 10′, 11′, 12′, 13′ may be fixed; for example, a Butler matrix or switches may be used (not shown). When a Butler matrix is used, there is typically one power amplifier per antenna beam 6, 7, 8, 9, 10, 11, 12, 13; 6′, 7′, 8′, 9′, 10′, 11′, 12′, 13′.

The antenna elements 29 may be dual polarized or comprise antenna elements of orthogonal polarizations. In that case, the polarizations associated with the different ports will be different.

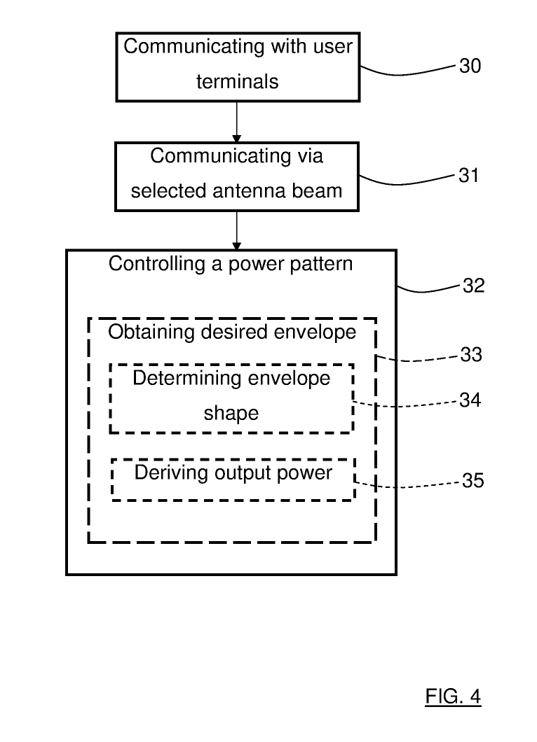

With reference to FIG. 4, the present disclosure also relates to a method in a wireless communication network node 1, where the method comprises:

30: Communicating with user terminals 3, 4, 5 by means of at least two antenna beams 6, 7, 8, 9, 10, 11, 12, 13 constituting a grid of beams.

31: Communicating with each user terminal 3, 4, 5 via at least one respective antenna beam 6, 7, 8, 9, 10, 11, 12, 13 that is selected in dependence of received power from said antenna beams 6, 7, 8, 9, 10, 11, 12, 13.

32: Controlling a power pattern of at least two controlled antenna beams 6, 7, 8, 9, 10, 11, 12, 13 in dependence of estimated signal power and interference created by each of said controlled antenna beams 6, 7, 8, 9, 10, 11, 12, 13, where each power pattern is defined as a product of the corresponding antenna beam's radiation pattern and transmitted power.

According to an example, the method comprises:

33: Controlling the power pattern of each antenna beam 6, 7, 8, 9, 10, 11, 12, 13; 6′, 7′, 8′, 9′, 10′, 11′, 12′, 13′ such that a desired envelope 15 of the power patterns of all antenna beams 6, 7, 8, 9, 10, 11, 12, 13; 6′, 7′, 8′, 9′, 10′, 11′, 12′, 13′ is obtained.

According to another example, the method comprises:

34: Determining a desired shape of said envelope (15).

35: Deriving the corresponding output power of the respective antenna beam 6, 7, 8, 9, 10, 11, 12, 13; 6′, 7′, 8′, 9′, 10′, 11′, 12′, 13′ from that desired shape.

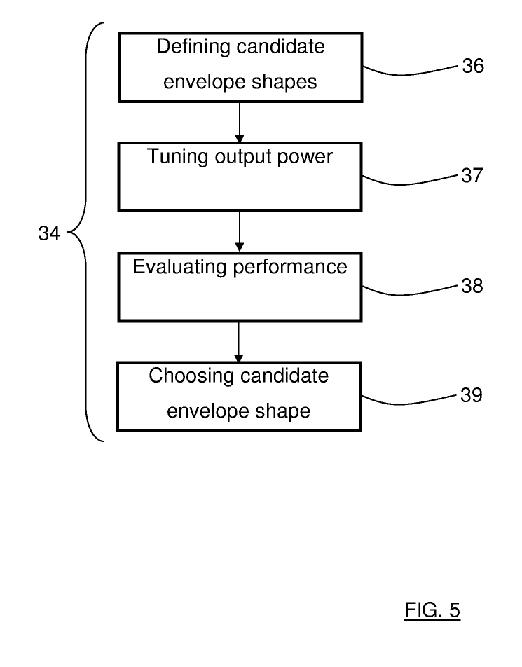

According to another example, with reference also to FIG. 5, the step 34 of determining a desired shape of said envelope 15 comprises:

36: Defining a set of candidate envelope shapes for a given node.

37: Tuning the output power of the respective antenna beam in accordance with the candidate envelope shapes.

38: Evaluating performance for each one of the candidate envelope shapes.

39: Choosing the candidate envelope shape 15 that best fulfills certain predetermined criteria.

The present disclosure is not limited to the above, but may vary within the scope of the appended claims. For example, the number of antenna beams may vary, from of at least two antenna beams to several hundreds, or even several thousands, of antenna beams.

Each user terminal 3, 4, 5 does not necessarily have to communicate via only one antenna beam, but via at least one respective antenna beam. The control unit 14 is arranged to control the power pattern of at least two controlled antenna beams; there may thus be antenna beams that are not controlled, even though all antenna beams 6, 7, 8, 9, 10, 11, 12, 13; 6′, 7′, 8′, 9′, 10′, 11′, 12′, 13′ are controlled in the example above, constituting controlled antenna beams 6, 7, 8, 9, 10, 11, 12, 13; 6′, 7′, 8′, 9′, 10′, 11′, 12′, 13′.

A wireless communication network node 1 according to the above may comprise one or more antenna arrangements 2.

When terms like orthogonal and the like are used, these terms are not to be interpreted as mathematically exact, but within what is practically obtainable.

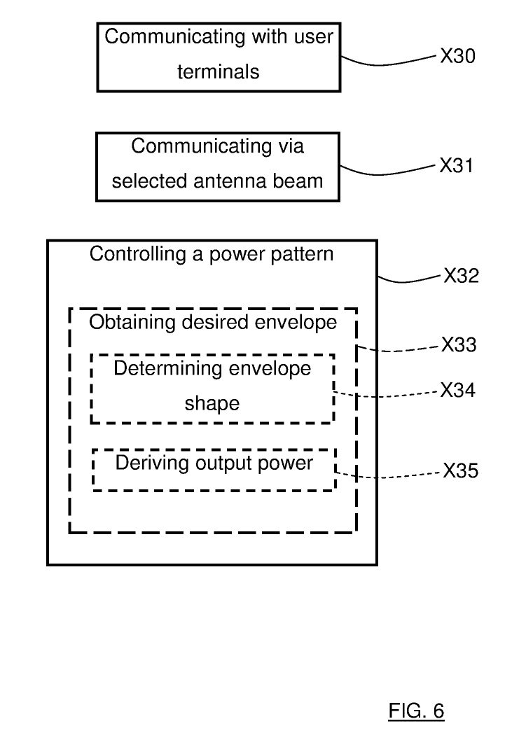

FIG. 6 shows a wireless communication network node arrangement that comprises: 1) A first communication module X30 configured to communicate with user terminals 3, 4, 5 by means of at least two antenna beams 6, 7, 8, 9, 10, 11, 12, 13 constituting a grid of beams; 2) A second communication module X31 configured to communicate with each user terminal via at least one respective antenna beam 6, 7, 8, 9, 10, 11, 12, 13 that is selected in dependence of received power from said antenna beams 6, 7, 8, 9, 10, 11, 12, 13; and 3) A controlling module X32 configured to control a power pattern of at least two controlled antenna beams 6, 7, 8, 9, 10, 11, 12, 13 in dependence of estimated signal power and interference created by each of said controlled antenna beams 6, 7, 8, 9, 10, 11, 12, 13, where each power pattern is defined as a product of the corresponding antenna beam's radiation pattern and transmitted power.

According to some aspects, the wireless communication network node arrangement further comprises an optional controlling module X33 configured to control the power pattern of each antenna beam 6, 7, 8, 9, 10, 11, 12, 13; 6′, 7′, 8′, 9′, 10′, 11′, 12′, 13′ such that a desired envelope 15 of the power patterns of all antenna beams 6, 7, 8, 9, 10, 11, 12, 13; 6′, 7′, 8′, 9′, 10′, 11′, 12′, 13′ is obtained.

According to some aspects, the wireless communication network node arrangement further comprises an optional determining module X34 configured to determine a desired shape of said envelope 15; and an optional deriving module X35, configured to derive the corresponding output power of the respective antenna beam 6, 7, 8, 9, 10, 11, 12, 13; 6′, 7′, 8′, 9′, 10′, 11′, 12′, 13′ from that desired shape.

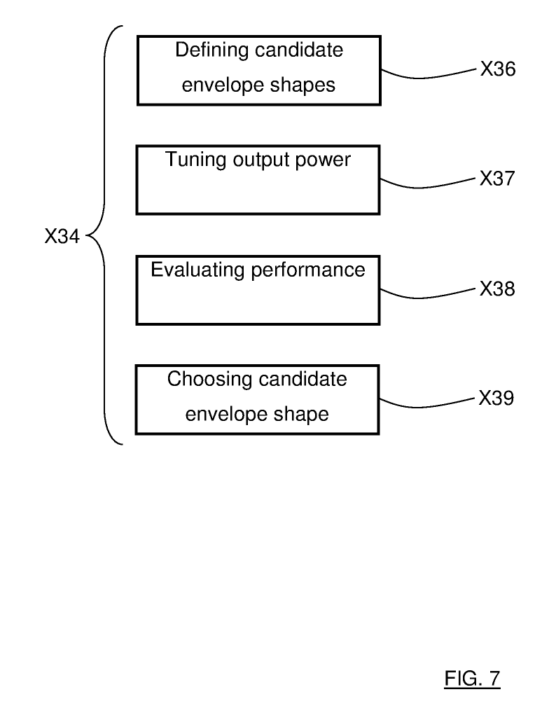

According to some aspects, with reference also to FIG. 7, the optional determining module X34 in turn comprises: 1) An optional defining module X36 configured to define a set of candidate envelope shapes for a given node; 2) An optional tuning module X37 configured to tune the output power of the respective antenna beam in accordance with the candidate envelope shapes; 3) An optional evaluating module X38, configured to evaluate performance for each one of the candidate envelope shapes; and 4) An optional choosing module X39, configured to evaluate the candidate envelope 15 shape that best fulfills certain predetermined criteria.

Generally, the present disclosure relates to a wireless communication network node 1 comprising at least one antenna arrangement 2, each antenna arrangement 2 being arranged to communicate with user terminals 3, 4, 5 by means of at least two antenna beams 6, 7, 8, 9, 10, 11, 12, 13 constituting a grid of beams, where each user terminal 3, 4, 5 is arranged to communicate via at least one respective antenna beam 6, 7, 8, 9, 10, 11, 12, 13 that is selected in dependence of received power from said antenna beams 6, 7, 8, 9, 10, 11, 12, 13, wherein the wireless communication network node 1 comprises a control unit 14 that is arranged to control a power pattern of at least two controlled antenna beams 6, 7, 8, 9, 10, 11, 12, 13 in dependence of estimated signal power and interference created by each of said controlled antenna beams 6, 7, 8, 9, 10, 11, 12, 13, where each power pattern is defined as a product of the corresponding antenna beam's radiation pattern and transmitted power.

According to an example, the control unit 14 is arranged to control the power pattern of each antenna beam 6, 7, 8, 9, 10, 11, 12, 13 such that a desired envelope 15 of the power patterns of all antenna beams 6, 7, 8, 9, 10, 11, 12, 13 is obtained.

According to an example, the control unit 14 is arranged to first determine a desired shape of said envelope 15, and from that desired shape derive the corresponding output power of the respective antenna beam 6, 7, 8, 9, 10, 11, 12, 13; 6′, 7′, 8′, 9′, 10′, 11′, 12′, 13′.

According to an example, the control unit 14 is arranged to determine a desired shape of said envelope 15 by defining a set of candidate envelope shapes for a given node, tune the output power of the respective antenna beam in accordance with the candidate envelope shapes, evaluate performance for each one of the candidate envelope shapes and then choose the candidate envelope shape that best fulfills certain predetermined criteria.

According to an example, the power patterns are controlled in dependence of results from interference and traffic load analysis, visual observations of the network deployment, and/or continuous non-disruptive network measurements.

According to an example, each user terminal 3, 4, 5 is arranged to communicate via one antenna beam 6, 7, 8, 9, 10, 11, 12, 13 that is selected in dependence of received beam reference signal power of beam-specific reference signals (BRSs), transmitted via the antenna beams 6, 7, 8, 9, 10, 11, 12, 13.

According to an example, the control unit 14 is arranged to apply different output power for BRS and data signals for each antenna beam 6, 7, 8, 9, 10, 11, 12, 13.

According to an example, the antenna beams 6, 7, 8, 9, 10, 11, 12, 13 are fixed.

According to an example, each antenna arrangement 2 comprises a plurality of antenna elements 29 and at least two antenna ports 16, 17, 18, 19 that in turn are connected to a beamforming arrangement 20, where the beamforming arrangement 20 comprises at least two beam ports 21, 22, 23, 24, 25, 26, 27, 28; one beam port for each antenna beam 6, 7, 8, 9, 10, 11, 12, 13.

Generally, the present disclosure also relates to a method in a wireless communication network node 1, where the method comprises:

30: communicating with user terminals 3, 4, 5 by means of at least two antenna beams 6, 7, 8, 9, 10, 11, 12, 13 constituting a grid of beams;

31: communicating with each user terminal via at least one respective antenna beam 6, 7, 8, 9, 10, 11, 12, 13 that is selected in dependence of received power from said antenna beams 6, 7, 8, 9, 10, 11, 12, 13;

32: controlling a power pattern of at least two controlled antenna beams 6, 7, 8, 9, 10, 11, 12, 13 in dependence of estimated signal power and interference created by each of said controlled antenna beams 6, 7, 8, 9, 10, 11, 12, 13, where each power pattern is defined as a product of the corresponding antenna beam's radiation pattern and transmitted power.

According to an example, the method comprises:

33: controlling the power pattern of each antenna beam 6, 7, 8, 9, 10, 11, 12, 13; 6′, 7′, 8′, 9′, 10′, 11′, 12′, 13′ such that a desired envelope 15 of the power patterns of all antenna beams 6, 7, 8, 9, 10, 11, 12, 13; 6′, 7′, 8′, 9′, 10′, 11′, 12′, 13′ is obtained.

According to an example, the method comprises:

34: determining a desired shape of said envelope 15; and

35: deriving the corresponding output power of the respective antenna beam 6, 7, 8, 9, 10, 11, 12, 13; 6′, 7′, 8′, 9′, 10′, 11′, 12′, 13′ from that desired shape.

According to an example, the step 34 of determining a desired shape of said envelope 15 comprises:

36: defining a set of candidate envelope shapes for a given node;

37: tuning the output power of the respective antenna beam in accordance with the candidate envelope shapes;

38: evaluating performance for each one of the candidate envelope shapes; and

39: choosing the candidate envelope 15 shape that best fulfills certain predetermined criteria.

According to an example, the power patterns are controlled in dependence of results from interference and traffic load analysis, visual observations of the network deployment, and/or continuous non-disruptive network measurements.

According to an example, communication between a wireless communication network node 1 and user terminals 3, 4, 5 uses one antenna beam 6, 7, 8, 9, 10, 11, 12, 13 that is selected in dependence of received beam reference signal power of beam-specific reference signals (BRSs), transmitted via the antenna beams 6, 7, 8, 9, 10, 11, 12, 13.

According to an example, different output power is applied for BRS and data signals for each antenna beam 6, 7, 8, 9, 10, 11, 12, 13.

1. A wireless communication network node, the wireless communication network node comprising:
at least one antenna arrangement, each antenna arrangement being arranged to communicate with user terminals by means of at least two antenna beams constituting a grid of beams, where each user terminal is arranged to communicate via at least one respective antenna beam that is selected in dependence of received power from said antenna beams; and
a control unit that is arranged to control a power pattern of at least two controlled antenna beams in dependence of estimated signal power and interference created by each of said controlled antenna beams, where each power pattern is defined as a product of the corresponding antenna beam's radiation pattern and transmitted power.

2. The wireless communication network node of claim 1, wherein the control unit is arranged to control the power pattern of each antenna beam such that a desired envelope of the power patterns of all antenna beams is obtained.

3. The wireless communication network node of claim 2, wherein the control unit is arranged to first determine a desired shape of said envelope, and from that desired shape derive the corresponding output power of the respective antenna beam.

4. The wireless communication network node of claim 3, wherein the control unit is arranged to determine a desired shape of said envelope by defining a set of candidate envelope shapes for a given node, tune the output power of the respective antenna beam in accordance with the candidate envelope shapes, evaluate performance for each one of the candidate envelope shapes and then choose the candidate envelope shape that best fulfills certain predetermined criteria.

5. The wireless communication network node of claim 1, wherein the power patterns are controlled in dependence of results from interference and traffic load analysis, visual observations of the network deployment, and/or continuous non-disruptive network measurements.

6. The wireless communication network node of claim 1, wherein each user terminal is arranged to communicate via one antenna beam that is selected in dependence of received beam reference signal power of beam-specific reference signals (BRSs) transmitted via the antenna beams.

7. The wireless communication network node of claim 6, wherein the control unit is arranged to apply different output power for BRS and data signals for each antenna beam.

8. The wireless communication network node of claim 1, wherein the antenna beams are fixed.

9. The wireless communication network node of claim 1, wherein each antenna arrangement comprises a plurality of antenna elements and at least two antenna ports that in turn are connected to a beamforming arrangement, where the beamforming arrangement comprises at least two beam ports; one beam port for each antenna beam.

10. A method in a wireless communication network node, the method comprising:
communicating with user terminals by means of at least two antenna beams constituting a grid of beams;
communicating with each user terminal via at least one respective antenna beam that is selected in dependence of received power from said antenna beams; and
controlling a power pattern of at least two controlled antenna beams in dependence of estimated signal power and interference created by each of said controlled antenna beams, where each power pattern is defined as a product of the corresponding antenna beam's radiation pattern and transmitted power.

11. The method of claim 10, wherein the method comprises:
controlling the power pattern of each antenna beam such that a desired envelope of the power patterns of all antenna beams is obtained.

12. The method of claim 11, wherein the method comprises:
determining a desired shape of said envelope; and
deriving the corresponding output power of the respective antenna beam from that desired shape.

13. The method of claim 12, wherein the step of determining a desired shape of said envelope comprises:
defining a set of candidate envelope shapes for a given node;
tuning the output power of the respective antenna beam in accordance with the candidate envelope shapes;
evaluating performance for each one of the candidate envelope shapes; and
choosing the candidate envelope shape that best fulfills certain predetermined criteria.

14. The method of claim 10, wherein the power patterns are controlled in dependence of results from interference and traffic load analysis, visual observations of the network deployment, and/or continuous non-disruptive network measurements.

15. The method of claim 10, wherein communication between a wireless communication network node and user terminals uses one antenna beam that is selected in dependence of received beam reference signal power of beam-specific reference signals (BRSs) transmitted via the antenna beams.

16. The method of claim 10, wherein different output power is applied for BRS and data signals for each antenna beam.
